(19) United States
(12) Patent Application Publication
(10) Pub. No.: US 2013/0261949 A1
(43) Pub. Date: Oct. 3, 2013

(54) SYSTEM AND METHOD FOR VEHICLE SEPARATION FOR A PLURALITY OF VEHICLES

(71) Applicant: Jan-Erik Eriksson, Linkoping (SE)

(72) Inventor: Jan-Erik Eriksson, Linkoping (SE)

(73) Assignee: SAAB AB, Linkoeping (SE)

(21) Appl. No.: 13/990,554

(22) PCT Filed: Dec. 22, 2010
(86) PCT No.: PCT/SE2010/051476

§ 371 Date: Jun. 13, 2013

(51) Int. Cl. G08G 5/04

(52) U.S. Cl. CPC G08G 5/04
USPC 701/300

(57) ABSTRACT

The invention pertains to a vehicle separation system for a plurality of vehicles wherein the system is arranged to cooperatively provide distance separation for the plurality of vehicles, the system comprising: a storage module arranged in each of the plurality of vehicles, wherein each storage module comprises information related to a reference trajectory for each of the plurality of vehicles, a deviation detection module arranged to detect a deviation from said reference trajectory and generate at least one deviation alert, a communication module arranged to communicate the at least one deviation alert to each of the plurality of vehicles in response to the detected deviation, a separation module arranged to calculate an update of the reference trajectory for at least one of the plurality of vehicles, based on the reference trajectory of each of the plurality of vehicles, in order to provide distance separation between the plurality of vehicles.

### TECHNICAL FIELD

The present invention relates to a method and system for control of vehicles.

In particular the invention relates to a method and system for control of un-manned and/or manned aerial vehicles.

Furthermore, the invention relates to software adapted to perform steps of the control method when executed on a computer.

### BACKGROUND OF THE INVENTION

Control of vehicles, manned or un-manned systems can be separated into two main categories including autonomous and manual control. Typically un-manned vehicle systems incorporate both autonomous and manual control to a varying degree. However, as a direct result from the development within the area of autonomous control, more and more functions are made autonomous resulting in that the need of additional abilities concerning safety such as for example management of separation distance is increasing. This is especially the case when un-manned vehicles are to be operated in a group in a limited control space and/or un-manned vehicles are to be operated together with manned vehicles in a limited control space.

Autonomous control typically requires predetermined data arranged to affect the control. For example, control laws need to be developed specifying conditions determining when to initiate what type of behavior and which extent of the behavior is appropriate. For example a certain control law may indicate that if altitude of an aerial vehicle is below a certain level a landing procedure should be initiated.

Both manned and un-manned vehicle systems such as for example UAV:s typically rely on mission data dictating what the system is arranged to accomplish during operation. The mission data can be either precompiled before initiating operations or altered/compiled during operations. The mission data can for example be arranged to provide a certain course and/or flight path that the vehicle is intended to follow by means of guidance instructions provided to an operator of the vehicle or by means of automatic control information that is provided to a flight control system (FCS) of the vehicle.

Path planning also referred to as route planning is usually employed both for manned and un-manned vehicles. Path planning is geared towards guidance of vehicles in order to achieve mission objectives as well as avoiding potential threats such as terrain, weather, traffic, and other obstructing or potentially dangerous objects. Path planning may for example provide conditions for travelling along a safe route, conditions for reaching an objective position at a predetermined time and/or maintaining a route while assuring that a safety distance to other vehicles. The guidance may be arranged to provide operator's instruction on how to operate the vehicle and/or to provide automatic control of the vehicle.

Generally there is a set of requirements that needs consideration when performing path planning. The requirements include management of time, position, airspace in respect of mission objectives. Furthermore the requirements may include that threats and potential collisions should be avoided, which determine requirements on traffic flow management.

Moreover, additional requirements may include that the vehicle is capable of travelling in radar shadow for as long time as possible or during a particular time-frame.

Path planning may also take into consideration maneuverability of each vehicle. The maneuverability may for example relate to maximum speed, acceleration and maximum turn rate of each respective vehicle.

Path planning can be performed off-line i.e. before operation of the vehicle is initiated, or on-line, i.e. during active operation of the vehicle.

In case that an un-expected event occurs such as for example that one or more threats and/or potential collision are detected, a planned path may have to be re-planned in order to ensure a continued safe operation of the vehicle. The one or more threats may for example comprise a static or dynamic threat on the ground or in the air. The re-planning of the vehicle path needs to take into consideration the at least one or more of the above mentioned requirements relating to the initial path planning. Furthermore re-planning of vehicle paths may need to consider requirements affecting the vehicle to return to the originally planned path in order to achieve the mission objectives.

Threat detection systems of today typically involve digital maps such as for example digital maps comprising Digital Terrain Elevation Data (DTED). The digital maps may be populated using information from satellites and/or using other intelligence gathered from elsewhere either on-line and/or off-line. When performing path planning on-line, off-line methods such as for example conditional grid based search methods including Dijkstra's method may be employed alone or in conjunction with one or more conditions and/or heuristics.

Apart from the digital maps, threat detection systems may comprise on-board sensors and/or other on-board or distanced equipment that detect threats and/or reacts to the detected threats on-line.

In general distance separation between multiple vehicles in crowded operating space and in particular aerial vehicles operating in a crowded airspace is achieved using predefined geographical boundaries such as for example restricted airspace and predefined virtual traffic lanes, also referred to as corridors. An aerial vehicle may for example be assigned a specific corridor and “slot-time” for which the corridor or part of the corridor is reserved for the particular aerial vehicle. However, the use of predefined corridors offers limited separation assurance in the sense that un-expected events may occur that may require maneuvers that guide the aerial vehicle outside the assigned corridor.

To maintain distance separation assurance, different types of on-line conflict detection and/or resolution methods can be employed. The conflict detection and/or resolution (CD&R) methods include detecting potential intruding entities that may intersect a predicted flight path of the own vehicle and/or managing generation of avoidance maneuvers to enable avoiding a collision with the detected intruder. Typically CD&R methods of today involve transponder based systems such as for example Traffic Collision avoidance system (TCAS), Automatic Dependent Surveillance Broadcast (ADS-B) or Airborne Collision Avoidance System (ACAS). The transponder based methods provide CD&R by means of transmitting a position of the own aircraft to surrounding aircrafts which in turn can calculate future intersecting flight paths and respond accordingly. The position may be transmitted continuously or requested by means of interrogating transponders arranged in the surrounding aircrafts. Apart from the transponder based methods, ground control such as Air Traffic Control (ATC) may be employed alone and/or in combination with the transponder based methods. ATC involves surveillance and guidance from operators and/or systems arranged on the ground.

CD&R may be divided into three levels including short-term-, mid-term- and long-term CD&R methods. The short-term level involves management of traffic flow for achieving collision free trajectories for a horizon up to hours. The mid-term level involves management of traffic flow for achieving collision free trajectories for a horizon up to tenths of minutes. The short-term level involves management of traffic flow for achieving collision free trajectories for a horizon up to five to ten minutes.

Other CD&R methods involve using on-board sensors of active or passive type such as for example radar or electro/optical (EO) sensors to detect intruding entities in order to be able to provide information of intersecting flight paths and respond accordingly.

CD&R methods may further be categorized in one or more of the following categories. Centralized CD&R methods rely on a central system such as for example a ground control station that perform surveillance of airspace. De-centralized CD&R methods use local modules arranged in each vehicle to perform conflict detection and conflict resolution locally. Cooperative CD&R methods may utilize negotiation of joint avoidance manoeuvres to cater for safe separation distance.

However, moving from local distance separation involving conflict detection and resolution systems to centralized or de-centralized cooperative systems in attempts to increase system efficiency tends to decrease safety, determinism and increase complexity related to system implementation and functionality.

Accordingly, there is a need in the art of distance separation involving conflict detection and resolution to present improved methods, intended to increase safety, facilitate system implementation and functionality.

### OBJECTIVE OF THE INVENTION

It is therefore an objective of the present invention to provide a method a system and a computer program performing said method, that facilitates conflict detection and resolution that achieve increased safety, facilitated system implementation and functionality in regard of distance separation between vehicles.

### SUMMARY OF THE INVENTION

This objective is achieved according to the present invention by a vehicle separation system for a plurality of vehicles. The system is arranged to cooperatively provide distance separation for the plurality of vehicles. The system comprising a storage module arranged in each of the plurality of vehicles, wherein each storage module comprises information related to a reference trajectory for each of the plurality of vehicles, a deviation detection module arranged in each of the plurality of vehicles, wherein said deviation detection module is arranged to detect at least one deviation from said reference trajectory an generate at least one deviation alert, a communication module arranged in each of the plurality of vehicles wherein the communication module is arranged to communicate the deviation alert to each of the plurality of vehicles in response to the detected deviation, a separation module arranged in each of the plurality of vehicles and wherein said separation module is arranged to calculate an update of the reference trajectory for at least one of the plurality of vehicles in response to the at least one deviation alert, based on the reference trajectory of each of the plurality of vehicles, in order to provide distance separation between the plurality of vehicles.

It is achieved that distance separation between the plurality of vehicles can be performed in a safe fashion while transmitting a minimal amount of information between the plurality of vehicles. Accordingly, distance separation can be performed utilizing a minimal amount of bandwidth. It is further achieved that distance separation can be performed between the plurality of vehicles without transmitting information that relates to the historical, current and/or future position of each of the plurality of vehicles. This is beneficial since the information relating to the position of the plurality of vehicles transmitted using wireless transmission techniques otherwise could be intercepted by enemy forces.

The system is in one option further characterized in that the deviation detection module is arranged to detect at least one cause for the detected deviation, the communication module is arranged to communicate the at least one cause to each of the plurality of vehicles and the separation management module is arranged to calculate an update of the reference trajectory for at least one of the plurality of vehicles, based on the reference trajectory of each of the plurality of vehicles, the reference time and the at least one detected cause.

By this is achieved that distance separation can be performed with increased efficiency with a reduced number of subsequent calculation related to the update of the reference trajectory since the update of the reference trajectory of the at least one of the plurality of vehicles can be tailored to current operating conditions based on detected limitations inflicting vehicle performance associated to the at least one of the plurality of vehicles.

The system is in one option further characterized in that the separation module of each of the plurality of vehicles comprises substantially identical algorithms for calculating the update of the reference trajectory.

The system is in one option further characterized in that the reference trajectory for each of the plurality of vehicles is time referenced, the system comprising a time keeping module arranged in each of the plurality of vehicles, wherein the time keeping module is arranged to track a reference time and wherein the separation management module is arranged to calculate the update of the reference trajectory for at least one of the plurality of vehicles in response to the at least one deviation alert based on the time referenced reference trajectory of each of the plurality of vehicles and the reference time.

By this is achieved that each of the plurality has access to a time dependent location determining the location for each of the plurality as a function of time. It is further achieved that calculation of the update of the at least one of the plurality of vehicles can be performed based on considering the time referenced reference trajectory for each of the plurality of vehicles and the reference time. Accordingly, two or more of the reference for each of the plurality of vehicles and/or the update of the reference trajectory for the at least one of the plurality of vehicles may be allowed to intersect as long as the intersection occur at different instants of time.

The system is in one option further characterized in that the storage module associated to each of the plurality of vehicles is arranged to store the update of the reference trajectory for the at least one of the plurality of vehicles.

By this is achieved that each of the plurality of vehicles are always provided with information relating to positional information by means of having access to the latest version i.e. update of the reference trajectory for each of the plurality of vehicles.

The system is in one option further characterized in that the separation management module is arranged to calculate the update of the reference trajectory based on the reference trajectory of each of the plurality of vehicles and at least one previously calculated update of the reference trajectory of at least one of the plurality of vehicles.

By this is achieved that distance separation can be performed even if one or more of the plurality of vehicles have been provided one or more calculated update of the reference trajectory.

The system is in one option further characterized in that that the cause relate to at least one option of a group comprising altered wind speed, altered wind direction, altered wind mass, altered weather, altered mission, manual override operator control, decreased engine capacity, decreased maneuverability and decreased fuel supply.

The system is in one option further characterized in that the system comprises a threat detection module arranged in each of the plurality of vehicles, wherein said threat detection module is arranged to detect at least one threat based on sensor data and communicate at least one position of the at least one detected threat to each of the plurality of vehicles.

The system is in one option further characterized in that the separation module is arranged to calculate the update of the reference trajectory in response to a detected threat, based on the at least one position of the at least one threat the reference time and the predetermined reference trajectory of each of the plurality of vehicles.

By this is achieved that distance separation can be performed both with respect to each of the plurality of vehicles and other potentially threatening objects such as for example entities not included in the vehicle separation system.

The system is in one option further characterized in that the reference trajectory for each of the plurality of vehicles comprise waypoints that are intended to be traversed, wherein the waypoint are surrounded by a protected volume (PV) wherein the separation management module is arranged to consider the protected volume when calculating the updated reference trajectory for at least one of the plurality of vehicles so that the protected volume (PV) associated to the reference trajectory of different vehicles of the plurality of vehicles does not intersect.

By this is achieved that a safer distance separation can be performed since a minimum safety distance always can be maintained between each of the plurality of vehicles. By always maintaining a minimum distance between each of the plurality of vehicles Near-Mid-Air-Collisions (NMAC:s) can effectively be avoided.

The system is in one option further characterized in that each of the plurality of vehicles are surrounded by a control volume (CV), wherein the detection module is arranged to detect a deviation from said reference trajectory based on if the associated vehicle of the plurality of vehicles is determined to be located outside the control volume (CV).

By this is achieved that distance separation can be performed with a minimal amount of nuisance deviation detections resulting in a large amount of calculations related to an update of the reference trajectory since each of the plurality of vehicles is allowed to operate within a tolerance zone without issuing a deviation detection.

The system is in one option further characterized in the in that a portion of the vehicle separation system is arranged in a central separation module.

By this is achieved that distance separation can be performed using a minimal amount of components arranged in each of the plurality of vehicles.

This objective is also achieved according to the present invention by a method for vehicle separation for a plurality of vehicles. The method is arranged to cooperatively provide distance separation for the plurality of vehicles, the method comprising the steps of: storing information relating to a reference trajectory for each of the plurality of vehicles in a memory unit associated to each of the plurality of vehicles, detecting at least one deviation from the reference trajectory based on the reference trajectory and generate at least deviation alert, communicating the at least one deviation alert to each of the plurality of vehicles, calculating an update of the reference trajectory for at least one of the plurality vehicles based on the reference trajectory of each of the plurality of vehicles, in order to provide distance separation between the plurality of vehicles.

The dependent claim defines optional characterizing features corresponding to some of those described in relation to the system.

This objective is also achieved by a computer programme comprising a programme code for performing the above described method steps, when said computer programme is run on a computer.

This objective is also achieved by a computer programme product comprising a program code stored on a computer readable media for performing the above described method steps, when said computer programme is run on the computer.

This objective is also achieved by a computer programme product directly storable in an internal memory of a computer, comprising a computer programmed for performing the above described method steps, when said computer programme is run on the computer.

### BRIEF DESCRIPTION OF THE DRAWINGS

FIG. 1. shows schematically a distributed “mission aware” cooperative distance separation system in accordance with an example of the invention.

FIG. 2. shows schematically a centralized “mission aware” cooperative distance separation system in accordance with an example of the invention.

FIG. 3. shows a schematic block diagram of components of the path planning system in accordance with an example of the invention.

FIG. 4. shows a schematic illustration of a reference trajectory in accordance with an example of the invention.

FIG. 5. shows a schematic illustration of volumes associated to the reference trajectory in accordance with an example of the invention.

FIG. 6. shows a schematic block diagram of components of the path planning system in accordance with an example of the invention.

FIG. 7. shows a schematic illustration of a flow diagram for a method to generate configuration data in accordance with an example of the invention.

### DETAILED DESCRIPTION

The present invention is described to a large extent in this specification with reference to a system and method for planning paths involving at least two aerial vehicles. However, various different applications are possible, e.g. for use in land, sea or space vehicles. The vehicles may be military vehicles such as for example fighter jets, destroyers, un-manned combat aerial vehicles (UCAV:s) or civilian/commercial vehicles such as for example cars, commercial airliners, cruise ships, cargo ships, satellites or other types of vehicles known within the art.

The person skilled in the art will recognize that any computer system or systems that comprises suitable programming and/or processing means for operating in accordance with the disclosed method falls within the scope of the present invention. The suitable programming means may comprise any means for controlling a computer system to cause the computer system to execute the steps associated to the inventive method. The suitable programming means may for example comprise a processing unit or logic circuits coupled to a computer memory or electronic circuits which have the ability to store data such as for example machine readable instructions and/or program instructions. The computer memory being arranged to store the machine readable instructions and/or the program instructions for execution by a processing unit such as for example the processing means.

The present invention may also in one example be performed by means of a computer program product, such as for example a CD-ROM, DVD or other suitable recordable medium capable of storing machine readable instructions for use in any suitable data processing system. Thus, any computer system comprising means for performing the steps of the method of the present invention stored on the computer program product is capable of executing said steps.

The person skilled in the art will also understand that apart from implementing the method of the present invention in any computer system the present invention can as well be implemented as separate hardware components, a single hardware component or firmware or any combination thereof.

Referring to the drawings, and initially to FIG. 1, there is illustrated a distributed “mission aware” cooperative distance separation system for on-line distance separation according to an example of the present invention. The distributed “mission aware” cooperative distance separation system is also interchangeably referred to as a distance separation system throughout the description. The term “mission aware” that is used throughout the description is intended to denote that the system uses data associated to one or more mission in order to perform distance separation. The data associated to missions may for example relate to one or more reference trajectories comprising waypoints that the one or more vehicle is intended to traverse or waypoints that the one or more vehicles is intended to traverse at a particular instant of time i.e. time-referenced waypoints. The term cooperative that is used throughout the description is used to denote that the system involves a plurality of vehicles that cooperatively performs distance separation. The plurality of vehicles that are involved in the system are also referred to as participating vehicles throughout the description. The term distributed is used throughout the description to denote that each of participating vehicles is arranged to implement the distance separation system, or a portion thereof. The distance separation system is arranged to perform distance separation associated to a plurality of participating vehicles 1A-1C. Information indicating an identity of the participating vehicle having detected at least one deviation from its associated reference trajectory and at least one cause of the at least one detected deviation is communicated between the participating vehicles by the use of a wireless network N which interconnects the plurality of participating vehicles. The wireless network may for example comprise and Ad-Hoc network such as an Institute of Electrical and Electronics Engineers (IEEE) 802.11 network or other wireless network known within the art. The identity of the vehicle having detected the at least one deviation or the identity of the vehicle having detected the at least one deviation and at least one detected cause of the at least one detected deviation can be used by the system to cooperatively perform path re-planning also referred to as update of reference trajectory. The system may be implemented in a plurality of vehicles and/or at least one control station such as for example a plurality of manned and/or un-manned including vehicles or any combination thereof. The system may for example be arranged to provide one or more updated reference trajectories in order to avoid colliding with participating vehicles other than a control vehicle and/or avoid colliding with detected threats in response to a detected deviation. The term control vehicle is used throughout the description to denote the identity of the participating vehicle having detected the deviation from its associated reference trajectory.

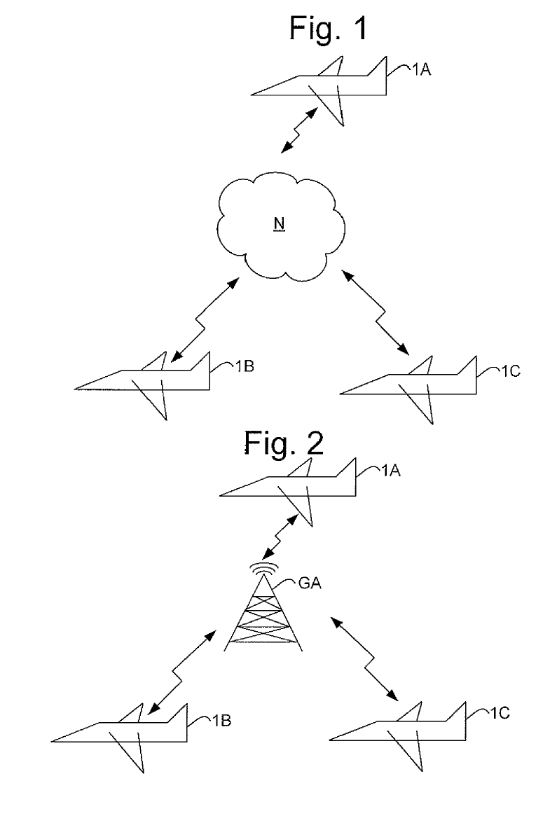

In FIG. 2 there is illustrated a centralized “mission aware” cooperative distance separation system, according to an example of the present invention. In this example portions of the “mission aware” cooperative distance separation system is implemented in at least one control station such as for example at least one ground control station GA or any other type of control station such as for example a control station implemented in at least one satellite. The at least one control station may be arranged to receive the information transmitted from the participating vehicles. The at least one control station may be arranged to compile the information transmitted from the participating vehicles and perform distance separation by communicating one or more updated reference to the participating vehicles based on the compiled information. The centralized “mission aware” cooperative distance separation system may be arranged to utilize any of the techniques mentioned below for providing separated reference trajectories to each of the participating vehicles on-line.

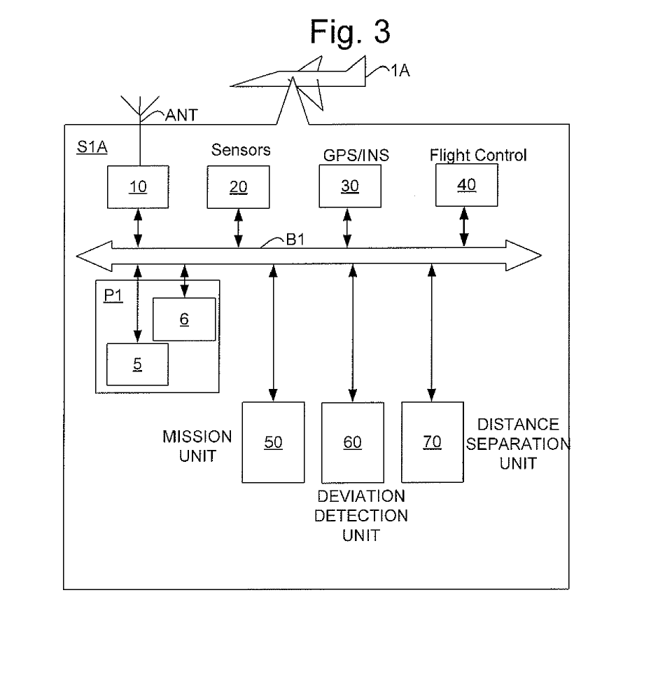

With reference to FIG. 3, the components of the “mission aware” cooperative distance separation system associated to one of the plurality of vehicles and/or the control station according to an example of the present invention are shown. Each vehicle 1A-1C and/or control station GA comprise a distance separation module S1A or portions thereof. The distance separation module may comprise a processing module P1 arranged to perform the inventive methods according to examples of the present invention. The processing module may comprise at least a processor 5 also referred to as a Central Processing Unit (CPU) and at least one memory unit 6. The at least one processor may for example be a microprocessor, programmable device, Field Programmable Gate Array (FPGA) or any other processing device known within the art. The at least one memory unit may be a Random Access Memory (RAM) unit and/or a non-volatile memory unit such as a Read Only Memory (ROM), optical disc drive, magnetic disc drive, flash memory, Electrically Erasable Read Only Memory (EEPROM) or any combination thereof. The at least one memory unit may comprise instructions to enable the at least one processor to provide services enabling the inventive methods according to examples of the present invention. The instructions may for example be associated to at least one operative system (OS) such as for example a real-time OS (RTOS) compliant with the Aeronautical Radio Inc. (ARINC) 653 specification enabling ARINC 653 compliant services to be provided. The services provided from the OS may be arranged to provide means for running application programs. The application programs may be stored on the at least one memory unit.

The distance separation module S1A comprises a system bus B1 arranged to provide communication between the components of the S1A.

The distance separation module S1A comprises a communication adapter 10 coupled to the system bus. The communication adapter is arranged to provide bi-directional communication of information between the distance separation modules of each of the participating vehicles and/or between one or more of the distance separation modules and the at least one control station by using the network and a wireless communication scheme.

The communication adapter may be coupled to an antenna arrangement ANT to enable communication from the distance separation module to remote platforms such as for example other distance separation modules arranged in control stations or other participating vehicles.

The system bus may be coupled to an Input/output (I/O) module to enable coupling to external components such as for example sensors 20, positional equipment 30 and/or a flight control system 40.

The flight Control System (FCS) 40 coupled to the system bus is arranged to control the operations relating to maneuvering the participating vehicle to which the FCS is coupled. The FCS may for example be arranged to control actuators arranged to control for example the engine and different flight control surfaces (aileron, rudder, elevator etc.) available in the participating vehicle.

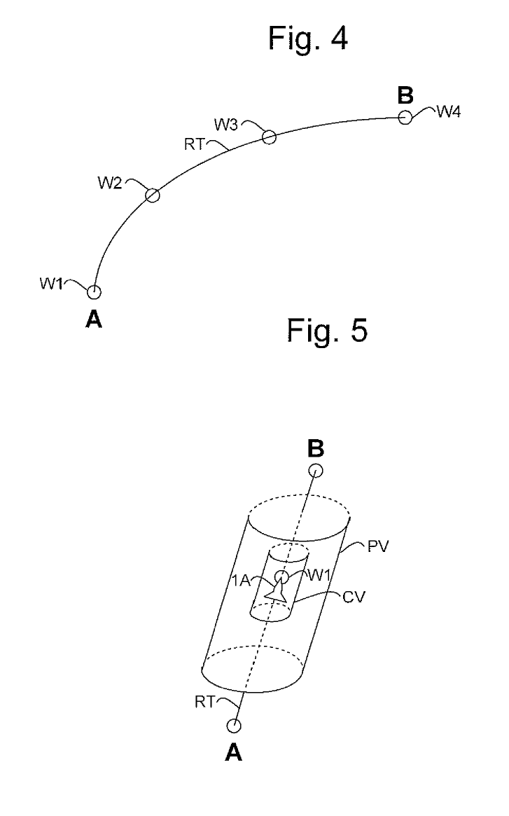

The distance separation module SIA comprises a mission module 50. The mission module is arranged to store various information pertaining to mission data. With reference to FIG. 4, the information pertaining to mission data may comprise at least one reference trajectory and/or one or more calculated update of the reference trajectory RT, which at least the control vehicle is intended to follow. The reference trajectory and/or calculated update of the reference trajectory associated to each participating vehicle may be provided to the flight control system of each of the participating vehicles based on transferring data from the mission module to the flight control system internally in the distance separation module. In one example the mission module comprise additional information relating to at least one additional reference trajectory, wherein each of the at least one additional reference trajectory relates to a corresponding participating vehicle other than the control vehicle.

The reference trajectory for each vehicle may indicate which waypoints W1-W4 that the vehicle is intended to traverse during operation from a start point A to a goal point B, associated to the mission. The waypoints may define coordinates or positions in three dimensional space such as for example using Cartesian coordinates x, y and z. The reference trajectory may define a substantially continuous path or course ranging from the start point to the goal point. The substantially continuous path may comprise straight and/or curved path segments.

In one example, the waypoints of the reference trajectory may be arranged substantially equidistantly along the reference trajectory.

In one example the waypoints of the reference trajectory may be arranged substantially non-equidistantly along the reference trajectory based on one or more factors such as for example the derivative of each point of the reference trajectory.

The number of waypoints for each of the reference trajectory may be arranged to be dependent on the cruise speed of the participating vehicle and/or length of the reference trajectory or any other suitable factor.

The reference trajectory for each participating vehicle may be accessible to the mission module 50 by means of being stored locally on the memory unit 6 associated to each of the vehicles.

In one example the reference trajectory for each of the participating vehicles may be time referenced. The time referenced reference trajectory comprises time-referenced waypoints. Each time referenced reference trajectory indicates for each vehicle which waypoints the vehicle is intended to traverse during a particular point in time during operation.

In one example the reference trajectories may be pre-stored on the memory unit before initiating operations i.e. off-line.

At least one reference trajectory for the control vehicle and the at least one additional reference trajectory for the at least one participating vehicle other than the control vehicle may be pre-calculated by an off-line path planning and/or mission planning process and/or apparatus. The off-line path planning and/or mission planning process and/or apparatus may be arranged to provide collision free reference trajectories.

In one example, the reference trajectory provided by the off-line path planning and/or mission planning process and/or apparatus is continuous. Additionally the provided reference trajectory may be adapted to properties such as for example type of vehicle such as for example military or civilian, vehicle properties of each individual vehicle such as for example aerodynamic properties comprising acceleration performance, maximum speed, cruise speed and turn ratio.

In one example the above mentioned dynamics of each individual participating vehicle may be predetermined and stored in the memory unit of each participating vehicle.

In one example the off-line path planning and/or mission planning process and/or apparatus may be arranged to provide reference trajectories that avoid at least one threat and/or threat zone. The at least one threat or threat zone may be dynamic or static. The at least one dynamic threat and/or threat zone may for example comprise a known trajectory of a non-participating vehicle or a potentially threatening weather zone. The at least one static threat and/or threat zone may for example comprise terrain obstacles, a known position of an anti-aircraft battery or any combination thereof.

In one example the distance separation module S1A is coupled to positional equipment 30 via the system bus. The positional equipment may for example comprise an Inertial Measurement Unit (IMU) and/or a Global Positioning System (GPS). The positional equipment is arranged to determine the location in three dimensions of the participating vehicle to which the positional equipment is coupled.

The distance separation module S1A comprises a time keeping device to enable tracking of a system global time reference. The time keeping device may for example be a time-of-day (TOD) software clock provided by the OS and/or a hardware clock associated to the processing module.

The time keeping device may in one example comprise a high quality time keeping device such as a high quality crystal oscillator, or be synchronized to external high quality time keeping devices such as by means of receiving pulse per second (PPS) signals from atomic clocks featured in Global Positioning Systems (GPS).

In one example the time keeping devices of the distance separation module S1A of each participating vehicle may be synchronized in time using the IEEE 1588 standard for a precision clock synchronization protocol for networked measurement and control systems.

The distance separation module S1A is coupled to a plurality of sensors 20. The sensors may provide information related to properties of the various vehicle subsystems and of an operating environment surrounding the vehicle.

The distance separation module S1A comprises a deviation detection module 60 coupled to the system bus. The deviation detection module comprises a deviation detection routine arranged to detect when the control vehicle is deviating from the reference trajectory associated to the control vehicle. The deviation detection routine is arranged to detect a deviation from the reference trajectory based on information comprising one or more of the following metric the reference trajectory provided by the mission module arranged in the control vehicle, information of the current location of the control vehicle provided from the positional equipment and/or information of the system global time reference provided by the time keeping device. In response to detecting at least one deviation from the reference trajectory the deviation detection module is arranged to trigger at least one deviation alert.

The deviation can for example be determined by the deviation detection module based on information provided from the positional equipment 30 relating to the current position of the control vehicle and information provided from the mission module 50 relating to the reference trajectory of the control vehicle. As an example the deviation detection module may be arranged to compare the information provided from the positional equipment relating to the current position of the control vehicle and the information provided from the mission module 50 relating to the reference trajectory for the control vehicle.

In one example the deviation can be determined by the deviation detection module based on information provided from the time keeping device relating to the current time indicated by the system global time reference and information provided from the mission module relating to the reference trajectory comprising time-referenced waypoints associated to the control vehicle. This means that each of the waypoints have an associated time-reference for when the waypoint is supposed to be reached.

In one example the deviation detection module is arranged to detect at least one cause associated to the detected deviation. The deviation detection module may for example be arranged to process information provided from the sensors 20 or any other suitable external and/or on-board monitoring equipment in order to detect the cause associated to the detected deviation.

The at least one cause for the detected deviation may comprise one or more causes selected from one or more group comprising environmental causes, navigational causes, vehicle performance causes. The environmental causes may comprise one or more causes selected from the group environmental causes comprising altered wind speed, altered wind direction, altered wind mass and altered weather. The navigational causes may comprise one or more causes selected from the group navigational causes comprising, altered mission provided from an on-line mission planner and manual override operator control. The vehicle performance causes may comprise one or more cause selected from the group vehicle performance causes comprising decreased engine capacity, decreased maneuverability and decreased fuel supply.

It is to be noted that the above mentioned group of causes only are examples and that the causes and/or group of causes may include fewer or additional suitable groups of causes and/or causes.

In one example one or more of the causes may be related to one or more vehicle properties selected from a group comprising the acceleration performance, maximum speed, cruise speed and turn ratio of the participating vehicles. The relation of one or more of the causes to one or more of the above mentioned properties determine which of the one or more properties are affected by the cause, which in turn effect the ability of each of the participating vehicle to perform one or more aspects of various maneuvers necessitated by the reference trajectory. Information concerning the relations between the one or more of causes and the one or more of vehicle properties may be stored on the memory unit of each participating vehicle.

In one example, the deviation detection module is arranged to detect at least one magnitude associated to the detected at least one cause. The magnitude of the detected cause comprises at least one parameter indicating to what extent the one or more vehicle properties related to the cause are affected. The magnitude associated to the detected at least one cause may be determined by the deviation detection module based on processing information provided from the sensors and information stored on the memory unit of each participating vehicle relating to relations between the information provided from the sensors and the predetermined vehicle properties.

As an example the deviation detection module may detect increased wind conditions based on data provided from one or more sensor as the cause for the detected deviation associated to the control vehicle.

As a further example the deviation detection module may detect that the control vehicle has deviated from the reference trajectory and that the wind has increased with 10%. The deviation detection module may then determine that the increased wind is the cause for the detected deviation and that the at least one parameter indicating the magnitude of the cause correspond to a first parameter indicating a 8% decrease of the maximum speed, a second parameter indicating a 5% decrease of cruise speed and a third parameter indicating a 5% decrease in acceleration performance.

As an additional example the deviation detection module may detect that the control vehicle has deviated from the reference trajectory and that the engine capacity has decreased with 30% and that the at least one parameter indicating the magnitude of the cause correspond to a fourth parameter indicating a 30% decrease of the maximum speed, a fifth parameter indicating a 30% decrease of cruise speed and a sixth parameter indicating a 30% decrease in acceleration performance.

The distance separation module comprises a separation management module 70. The separation management module is arranged to calculate one or more updates of the reference trajectory for one or more of the participating vehicles in response to the at least one deviation alert provided by the control vehicle.

In response to the at least one triggered deviation alert the deviation detection module of the control vehicle having detected the deviation is arranged to communicate information relating to one or more of the following data the deviation alert, the identity of the control vehicle, the cause for the detected deviation, the associated magnitude of the detected cause to the separation management module of the control vehicle. Additionally the deviation module can transmit information relating to one or more of the above mentioned data to one or more of each of the participating vehicles via the communication adapter and the wireless network and/or control station.

In one example the operations of the distance separation system may support fully automated operations meaning that the distance separation system can automatically perform safe distance separation between participating vehicles by calculating one or more updates of the reference trajectory and automatically forwarding control commands relating to the one or more updated reference trajectory to the FCS of each participating vehicle.

In one example the operations of the distance separation system may support semi automated operations meaning that the distance separation system can semi automatically perform safe distance separation between participating vehicles by calculating one or more updates of the reference trajectory and forwarding guidance control commands relating to the one or more updates of the reference trajectory to one or more operators of each participating vehicle. More details on the separation management module will be described below.

The one or more updates of the reference trajectory may be calculated by the separation management module based on one or more of the following metrics comprising, the identity of the control vehicle and/or the identity of other participating vehicles, mission objectives of the control vehicle and/or mission objectives of the participating vehicles other than the control vehicle, the reference trajectory of the control vehicle and/or the reference trajectory of one or more of the participating vehicles other than the control vehicle, the at least one detected cause for the at least one detected deviation of the control vehicle, the at least one magnitude associated to the at least one detected cause, the position of the control vehicle provided by the positional equipment and the reference time provided by the time keeping device.

In one example the separation management module may be arranged to calculate the one or more updates of the reference trajectory using the above mentioned metric as input data and/or as various criteria and any suitable navigational algorithms.

The one or more calculated updated reference trajectories may comprise one or more modified trajectories with modifications concerning one or more of the following metric; velocity, waypoints relating to the time of when one or more of the waypoints should be reached and the actual location in space of the one or more of the waypoints.

In one example the separation management module may be arranged to cycle through the reference trajectory and or the one or more calculated updates of the reference trajectory for each of the participating vehicles in a predetermined sequence.

The separation management module may then be arranged to determine during the cycle if the calculated update of the reference trajectory for the control vehicle intersect the reference trajectory of any of the other participating vehicles and/or any other during the current calculation cycle previously calculated one or more updates of the reference trajectory for the one or more participating vehicles.

If the separation management module determine that the reference trajectory of any of each of the participating vehicles is determined to intersect one or more of the calculated update of the reference trajectory for one or more of the participating vehicles the separation management is arranged to calculate an update of the reference trajectory for the one or more vehicles determined to intersect the one or more calculated updates of the reference trajectory for the one or more participating vehicles.

In one example, when calculating the one or more updated reference trajectory each participating vehicle may be assigned with a vehicle priority. The vehicle priorities are arranged to provide the predetermined sequence associated to the participating vehicles determining in which to determine if the reference trajectory intersect and/or in which to calculate the one or more updated reference trajectory. As an example a first participating vehicle issuing the deviation alert i.e. control vehicle may be assigned with a first priority, a second participating vehicle which is determined to be closest in distance to the first participating vehicle may be assigned with a second priority etc. Accordingly, the update of the reference trajectory of the first vehicle is calculated before the update of the reference trajectory of the second vehicle is calculated.

In one example the predetermined sequence is dynamic and arranged based on a measured distance between the current location of the control vehicle and the current location of the other participating vehicles.

In one example the separation management module is arranged to calculate the one or more updates of the reference trajectory for the control vehicle based on the magnitude of the at least one detected cause so that the calculated update of the reference trajectory of the control vehicle can be followed given the operating conditions of the control vehicle provided from the magnitude without deviation from the calculated update of the reference trajectory.

In one example, the separation management module may be provided with information relating to a terrain database and/or threat database. The information relating to the terrain database and/or threat database can be incorporated into the metrics used by the separation management module when calculating the one or more updates of the reference trajectory. As an example the separation management module can calculate the one or more updates of the reference trajectory so that each reference trajectory provides a safe distance away from terrain and/or threats.

In one example, the information associated the threat database may comprise at least one threat zone defining the extent in space of the at least one threat. As an example the at least one threat zone associated to a threat comprising an anti-aircraft battery may define a potentially threatening three dimensional region determined by the range of said anti-aircraft battery.

In one example, after the one or more updated reference trajectory has been calculated the separation management module may be arranged to store the one or more updates of the reference trajectory for at least one of the participating vehicles. The one or more calculated update of the reference trajectory may be stored in the memory unit which is accessible to the mission module.

In one example the reference trajectory and/or the one or more calculated updates of the reference trajectory may be stored as a control command sequence.

In one example, the one or more calculated updates reference trajectory for the control vehicle may be directly provided by the separation management module or mission module to the FCS of the participating vehicle for which the one or more updated reference trajectory is calculated or alternatively be provided as guidance control commands to the one or more operator of the participating vehicle for which the one or more updated reference trajectory is calculated.

In one example, when calculating the one or more updates of the reference trajectory the separation management module of each participating vehicle is arranged to consider the reference trajectory of all participating vehicles in order to assure a safe distance separation i.e. none of the current reference trajectory or the one or more updates of the reference trajectory associated to each of the participating vehicles intersect. The term current is used to denote the reference trajectory for each of the participating vehicles currently intended to be followed. As an example the separation management module may be arranged to calculate the one or more updates of the reference trajectory such that a minimum safety distance between the reference trajectories of each participating vehicles is always kept.

In one example, the separation management module may be arranged to calculate the one or more updates of the reference trajectory based on the reference trajectory of all participating vehicles with the associated time referenced waypoints and the reference time in order to assure a safe distance separation i.e. none of the reference trajectory of each of the participating vehicles intersect at one or more particular instants of time as indicated by the time reference associated to the waypoints of each of the reference trajectory of each of the participating vehicles. Accordingly, the reference trajectory of the one or more of the participating vehicles may intersect i.e. have one or more location provided by paths between waypoints in common but the reference trajectory of the one or more of the participating vehicles may never intersect at one or more particular instants of time i.e. none of the participating vehicles are allowed to be located at the same location at the same instant of time.

In one example each of the separation management modules 70 may comprise identical algorithms and/or cloned software for calculating the one or more updates of the reference trajectory.

Since the participating vehicles have access to the same input data and by the implementation of identical algorithms and/or cloned software the separation management module of each participating vehicles is capable of calculating the one or more updates of the reference trajectory for one or more of the participating vehicle. Furthermore the one or more calculated updates of the reference trajectory for each of the participating vehicle will be substantially identical irrespectively in which of the participating the separation management module that calculates the one or more updated reference trajectory is arranged. The one or more calculated updates of the reference trajectory will be substantially identical since the separation management module arranged in each of the participating vehicles uses substantially identical algorithms for calculating the one or more updates of the reference trajectory and since each of the separation management modules are provided with the same input data i.e. the deviation alert comprising one or more of the following metric the at least one cause for the detected deviation, the identity of the control vehicle, the time-referenced reference trajectory of each of the participating vehicles, the current position of the control vehicle provided by the positional equipment and the reference time provided by the time-keeping device

In one example with reference to FIG. 5 the time-referenced waypoints W1 of the reference trajectory RT is surrounded by a protected volume PV. The protected volume defines for each participating vehicle 1A-1C a time dependent safety zone around each of the participating vehicle which no other participating vehicle is allowed to enter at substantially the same instant of time. The time dependent safety zone is dependent on the time referenced waypoint.

In one example, the protected volume associated to each of the participating vehicle defines a cylindrical shape substantially centered around each of the participating vehicles with its rotational axis aligned with the reference trajectory of each of the participating vehicles.

In one example the protected volume associated to each of the participating vehicles defines a spherical shape substantially centered around each of the participating vehicles.

It is to be noted that the protected volume PV may define other suitable geometrical shapes in one, two or three dimensions.

In one example the size of the protected volume for each of the participating vehicles is predetermined based on one or more of the following metrics: vehicle performance, communication performance and minimum required separation distance, type of the vehicle and behavior of the vehicle.

The vehicle performance may relate to one or more of the following vehicle performance categories: aerodynamic performance, climb-rate, maximum speed, cruise speed and turn ratio.

The minimum required separation distance may for example be user defined or defined by requirements on one or more minimum safety distance stipulated by the International Civil Aviation Organization (ICAO) or one or more minimum safety distance defined by any other standardization organization or defined by a time-based model determining a Time-to-go (TTG) to Closest-Point-of-Approach (CPA) also referred to as the “TAU” concept which is implemented in Traffic Collision Avoidance Systems (TCAS) or a or any combination thereof.

The communication performance relates to the capacity of the wireless network and/or each communication module associated to each of the participating vehicles coupling each participating vehicle to the wireless network. As an example the protected volume can be adapted in size based on the time-delay caused by transmitting information via the network. This implies that in case a the network and/or each communication module inflicts a small time-delay the protected volume can set to be relatively small in size and in case the network and/or each communication inflicts a large time-delay the protected volume can set to be relatively large in size.

In one example the protected volume is set up individually for each of the participating vehicles based on one or more of the above mentioned vehicle performance categories.

The type of vehicle may relate to if the vehicle is military or civilian.

The behavior of the vehicle may relate to if the vehicle is categorized as operating in one or more of the following modes attacking, transporting, pursuit, surveillance, dog-fight or any other suitable mode.

In one example the protected volume for one or more of the participating vehicles can be modified during operation i.e. on-line in response to changes affecting one or more of the above mentioned vehicle performance categories.

Information relating to the size of the protected volume of each participating vehicle can be pre-stored on the memory unit of the distance separation module associated to each of the participating vehicles.

In one example information relating to the size of the protected volume of each participating vehicle and/or information relating to a modified size of the protected volume of each participating vehicle can be up-loaded during system run-time i.e. on-line.

In one example the separation management module 70 may be arranged to consider the protected volume and/or control volume when calculating the updated reference trajectories. As an example the separation management module may when calculating at the one or more updates of the reference trajectory consider the protected volume of the control vehicle and the protected volume of the participating vehicles other than the control vehicle so that none of the protected volumes associated to any reference trajectory intersect at any one and the same future instant of time. This enables the separation management module to provide safe distance separation both between each of the participating and between each of the participating vehicles and the at least one detected threat.

In one example, with further reference to FIG. 5 in order to reduce the number of nuisance alerts leading to procedures performed by one or more distance separation module causing an update of one or more reference trajectory resulting from minor deviations from the reference trajectory a control volume CV is defined for each participating vehicle. The control volume defines for each participating vehicle a time dependent tolerance zone within which each participating vehicle can maneuver without generating an alert indicating a deviation from the reference trajectory. The time dependent tolerance zone is dependent on the time-referenced waypoint.

The minor deviations may for example be the result of external or internal disturbances affecting the ability for each participating vehicle to follow the reference trajectory. As an example the external disturbances may origin from environmental factors such as for example wind and the internal disturbance may origin from limited accuracy of instrumentation.

In one example the control volume associated to each of the participating vehicle defines a cylindrical shape substantially centered around each of the participating vehicle with its rotational axis aligned with the reference trajectory of each of the participating vehicle.

In one example the control volume associated to each of the participating vehicle defines a spherical shape substantially centered around each of the participating vehicle.

It is to be noted that the control volume may define other suitable geometrical shapes in one, two or three dimensions.

In one example the control volume is set up individually for each of the participating vehicles based on one or more of the above mentioned vehicle performance categories or based on one or more other condition affecting the performance of the vehicle.

In one example the size of the control volume is smaller than the size of the protected volume.

Information relating to the size of the control volume of each participating vehicle can be pre-stored on the memory unit of the distance separation module associated to each of the participating vehicles.

In one example the separation management module may be arranged to consider the control volume of the control vehicle when detecting a deviation from the reference trajectory associated to the control vehicle. As an example the separation management module of the control vehicle may be arranged to detect the at least one deviation from the reference trajectory based on determining if the control vehicle is located outside its associated control volume.

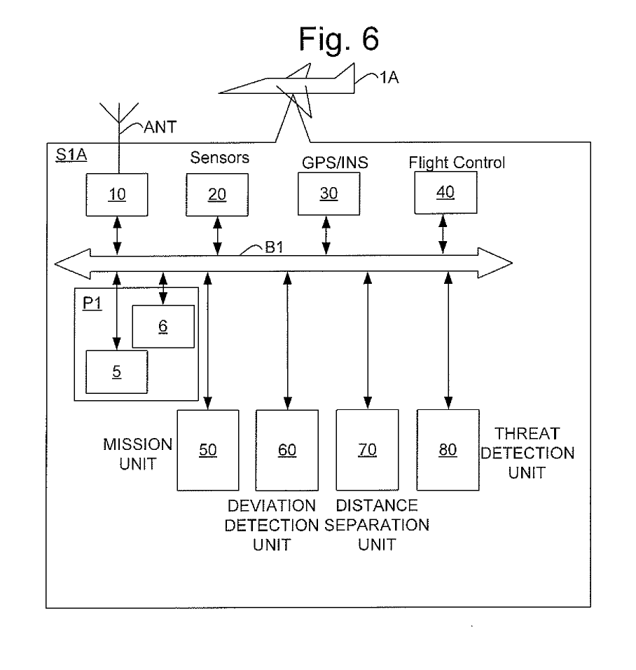

In one example with reference to FIG. 6 the distance separation module S1A may comprise a threat detection module 80. The threat detection module is coupled to sensors 20 associated to the control vehicle and/or coupled to other external data sources such as for example remote sensors via the communication module 10. The sensors may for example comprise one or more of the following sensors, radar, Doppler radar, synthetic aperture radar (SAR), laser range tinder (LRF), transponder such as for example a Mode-S and/or Mode-C transponder and a electro-optical/infra-red EO/IR sensor. The threat detection module is arranged to detect at least one threat based on data provided from the above mentioned sensors. In response to the detected at least one threat, the threat detection module is arranged to trigger a deviation alert and register detected threat as the cause of the deviation. The at least one threat may for example comprise one or more non-participating vehicle and/or unknown terrain and/or other potentially threatening structure. Additionally the threat detection module is arranged to register at least one position associated to the at least one detected threat. In response to the at least one detected threat the threat detection module is arranged to communicate information relating to the at least one position of the at least one detected threat to each of the participating vehicles.

In one example the separation management module is arranged to calculate the one or more updates of the reference trajectory for one or more of the participating vehicles based on the reference trajectory associated to one or more of the participating vehicles and the information relating to the cause detected threat and the at least one position of the at least one detected threat received from the control vehicle.

In one example the separation management module of the participating vehicles is arranged to calculate an avoidance maneuver for one or more of the participating vehicle in response to at least one detected threat and directly provide control commands relating to the avoidance maneuver to the flight control system. The avoidance maneuver can be calculated and provided to the flight control system before calculating the one or more updates of the reference trajectory.

The avoidance maneuver can be calculated by the separation management module based on a bearing measured from the participating vehicle for which the avoidance maneuver is to be calculated to the at least one position of the at least one detected threat, a distance measured between the participating vehicle for which the avoidance maneuver is to be calculated and the at least one position of the at least one detected threat, a distance measured between the participating vehicle for which the avoidance maneuver is to be calculated to the reference trajectory of one or more other participating vehicle, a distance measured between the participating vehicle for which the avoidance maneuver is to be calculated to a previously calculated avoidance maneuver of one or more other participating vehicle or any combination thereof.

In one example each of the separation management modules 70 may comprise identical algorithms and/or cloned software for calculating the avoidance maneuver for one or more of the participating vehicles.

In one example the avoidance maneuver may be calculated as a time referenced temporary update of the reference trajectory. The term temporary refers to that the temporary reference trajectory i.e. avoidance maneuver is only calculated for a relatively short time horizon in the future so that future updated reference trajectory can be calculated in time before an end location of the avoidance maneuver has been reached by the participating vehicle that is performing the avoidance maneuver. The time reference associated to the avoidance maneuver refers to that waypoints of the temporary reference trajectory are provided with a time reference each indicating a point in time when the vehicle is intended to traverse each of said waypoints.

The temporary update of the reference trajectory for one or more of the participating vehicles may in one example be stored in the memory unit of each of the participating vehicles.

In one example the separation management module may be arranged to calculated the one or more updated reference trajectory for the one or more participating vehicles based on one or more of the following metrics, the current time indicated by the time keeping means, the reference trajectory of the one or more of the participating vehicles, the one or more temporary reference trajectory of the one or more participating vehicles.

In one example in case the control vehicle has calculated an avoidance maneuver the separation management module of the control is arranged to communicate information relating to that the avoidance maneuver has been calculated to each of the participating vehicles. The separation management module of each of the participating vehicles may then calculate and store the avoidance maneuver for the control vehicle so as to provide information relating to the current location of the control vehicle during the avoidance maneuver.

In one example in case the control vehicle has calculated an avoidance maneuver and that the separation module of the control vehicle has communicated the information relating to that the avoidance maneuver has been calculated the separation management module of each of the participating vehicles is arranged to calculate one or more updates of the reference trajectory for one or more of the participating vehicles based on if the avoidance maneuver intersect one or more of the reference trajectory of each of the participating vehicles.

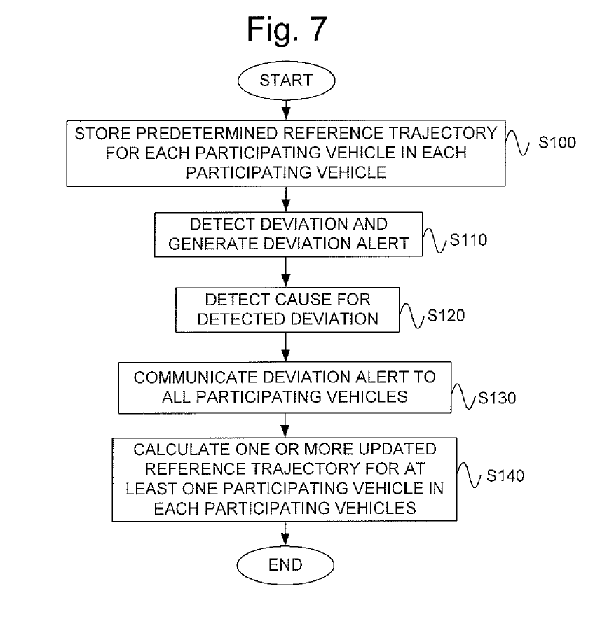

FIG. 7 schematically illustrates a flow diagram of a method according to an example of the present invention. This example relates to cooperatively performing distance separation on-line of at least one participating vehicle coupled to a network interconnecting the plurality of participating vehicles.

In a first method step S100 storing of predetermined mission data is performed i.e. information relating to the reference trajectory of each of the participating vehicles is stored in the memory unit of each of the participating vehicles. This means that the mission module of each of the participating vehicles have access to information related to the reference trajectory of each of the participating vehicles. After the method step S100 a subsequent method step S110 is performed.

In the method step S110 a deviation from at least one reference trajectory associated to at least one of the participating vehicles is detected and at least one deviation alert is generated. After the method step S110 a subsequent method step S130 is performed.

In the method step S130 the at least one deviation alert is communicated to each of the participating vehicles. After the method step S130 a subsequent method step S140 is performed.

In the method step S140 the reference trajectory of one or more of the participating vehicles is updated. After the method step S140 the method may be repeated from the method step S110 so that a new detected deviation may result in one or more updated reference trajectory.

In one example a method step S120 is performed between the method step S110 and S130. In the method step S120 at least one cause for the detected deviation is detected in response to the generated deviation alert. After the method step S120 the subsequent method step S130 is performed.

In one example in the method step S130 the detected deviation and the at least one detected cause are communicated to each of the participating vehicles. After the method step S130 the subsequent method step S140 is performed.

Many modifications and variations will be apparent to practitioners skilled in the art without departing from the scope of the invention as defined in the appended claims. The examples were chosen and described in order to best explain the principles of the invention and its practical applications, thereby enabling others skilled in the art to understand the invention for various examples and with various modifications as suited to the particular use contemplated.

1-15. (canceled)

16. A vehicle separation system for a plurality of vehicles (1A-1C), wherein the system is configured to cooperatively provide distance separation for the plurality of vehicles, the system comprising:
a storage module (50) arranged in each of the plurality of vehicles, wherein each storage module comprises information related to a reference trajectory (RT) for each of the plurality of vehicles;
a deviation detection module (60) arranged in each of the plurality of vehicles, wherein said deviation detection module is configured to detect at least one deviation from said reference trajectory (RT) and to generate at least one deviation alert;
a communication module (10) arranged in each of the plurality of vehicles wherein the communication module is configured to communicate the at least one deviation alert to each of the plurality of vehicles in response to the detected deviation; and
a separation module (70) arranged in each of the plurality of vehicles, wherein said separation module is configured to calculate an update of the reference trajectory (RT) for at least one of the plurality of vehicles in response to the at least one deviation alert, said update being based at least in part on the reference trajectory of each of the plurality of vehicles, in order to provide distance separation between the plurality of vehicles.

17. The system according to claim 16, wherein:
the deviation detection module (60) is further configured to detect at least one cause for the detected deviation;
the communication module is further configured to communicate the at least one cause to each of the plurality of vehicles; and
the separation management module (70) is configured to calculate the update of the reference trajectory for at least one of the plurality of vehicles based on the reference trajectory of each of the plurality of vehicles, the reference time, and the at least one detected cause.

18. The system according to claim 16, wherein the separation module of each of the plurality of vehicles (1A-1C) comprises substantially identical algorithms for calculating the update of the reference trajectory.

19. The system according to claim 16, wherein:
the reference trajectory for each of the plurality of vehicles is time referenced; and
the system further comprises a time keeping module arranged in each of the plurality of vehicles, wherein:
the time keeping module is configured to track a reference time; and
the separation management module is configured to calculate the update of the reference trajectory for at least one of the plurality of vehicles in response to the detected deviation based on the time referenced reference trajectory of each of the plurality of vehicles and the reference time.

20. The system according to claim 16, wherein the storage module associated to each of the plurality of vehicles is configured to store the update of the reference trajectory for the at least one of the plurality of vehicles.

21. The system according to claim 16, wherein the separation management module is configured to calculate the update of the reference trajectory based on the reference trajectory of each of the plurality of vehicles and at least one previously calculated update of the reference trajectory of at least one of the plurality of vehicles.

22. The system according to claim 17, wherein the at least one cause relates to at least one option selected from the group consisting of: altered wind speed, altered wind direction, altered wind mass, altered weather, altered mission, manual override operator control, decreased engine capacity, decreased maneuverability, and decreased fuel supply.

23. The system according to claim 16, wherein the system comprises a threat detection module (80) arranged in each of the plurality of vehicles, wherein said threat detection module is configured to detect at least one threat based on sensor data and to communicate at least one position of the at least one detected threat to each of the plurality of vehicles.

24. The system according to claim 23, wherein the separation module is arranged to calculate the update of the reference trajectory in response to the at least one deviation alert, said calculation being based on the at least one position of the at least one threat, the reference time, and the reference trajectory of each of the plurality of vehicles.

25. The system according to claim 16, wherein:
the reference trajectory for each of the plurality of vehicles comprises waypoints that are intended to be traversed;
the waypoints are surrounded by a protected volume (PV); and
the separation management module is configured to consider the protected volume when calculating the updated reference trajectory for at least one of the plurality of vehicles in order to avoid that the protected volume (PV) associated to the reference trajectory of different vehicles of the plurality of vehicles intersect.

26. The system according to claim 16, wherein:
each of the plurality of vehicles is surrounded by a control volume (CV); and
the detection module is configured to detect a deviation from said reference trajectory based on if the associated vehicle of the plurality of vehicles is determined to be located outside the control volume (CV).

27. The system according to claim 16, wherein a portion of the vehicle separation system is arranged in a central separation module.

28. A method for vehicle separation for a plurality of vehicles wherein the method is configured to cooperatively provide distance separation for the plurality of vehicles, the method comprising the steps of:
storing information relating to a reference trajectory for each of the plurality of vehicles in a memory unit associated to each of the plurality of vehicles;
detecting at least one deviation from the reference trajectory based on the reference trajectory and generating at least one deviation alert;
communicating the at least one deviation alert to each of the plurality of vehicles; and
calculating an update of the reference trajectory for at least one of the plurality vehicles based on the reference trajectory of each of the plurality of vehicles, in order to provide distance separation between the plurality of vehicles.

29. The method according to claim 28, further comprising the steps of:
detecting at least one cause for the detected deviation based on information provided from sensors;
communicating information relating to the detected cause to each of the plurality of vehicles; and
calculating an update of the reference trajectory for at least one of the plurality vehicles based on the reference trajectory of each of the plurality of vehicles and the at least one detected cause.

30. A non-transitory computer program product comprising at least one computer-readable storage medium having computer-readable program code portions embodied therein, the computer-readable program code portions being configured to perform the method steps of claim 28.
